(19) United States
(12) Patent Application Publication
(10) Pub. No.: US 2003/0005965 A1
(43) Pub. Date: Jan. 9, 2003

(54) Multi-inlet orifice

(76) Inventor: Marc Flammia, Bailieboro (CA)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/682,009

(22) Filed: Jul. 9, 2001

(51) Int. Cl. G05D 7/00

(52) U.S. Cl. 137/602

(57) ABSTRACT

An orifice for a hydrostatic system includes a plurality of means for providing flow communication from a first side of the orifice to a second side of the orifice such that the flow communication is maintained when less than all of the means are blocked.

### BACKGROUND OF INVENTION

This invention relates generally to hydrostatic lubrication systems and, more particularly, to orifices for hydrostatic lubrication systems.

In a hydrostatic lubrication system, a lubricant, typically oil, is supplied under an external pressure sufficient to separate opposing surfaces of a machine. The lubricant forms a fluid film between the opposing surfaces and reduces friction and, accordingly, reduces wear of the opposing surfaces. The external pressure is provided by a pump and is typically metered though the use of an orifice. The orifice restricts flow therethrough and reduces a pressure provided by the pump to a lower pressure for use in the hydrostatic lubrication system.

The orifice is typically a precision hole that meters a lubrication fluid for a hydrostatic system. Typically, the lubrication fluid flows through a filter to remove particles that can block or plug the orifice. However, the filter is positioned away from the orifice and the lubrication fluid sometimes picks up debris originating between the filter and the orifice. The debris can cause a blockage of the orifice, which causes a failure of the hydrostatic system. A failure of the hydrostatic system leads to increased wear and, sometimes, a complete breakdown of the machine requiring an expenditure of repair costs.

### SUMMARY OF INVENTION

In one aspect, an orifice for a hydrostatic system includes a plurality of means for providing flow communication from a first side of the orifice to a second side of the orifice such that the flow communication is maintained when less than all of the means are blocked.

In another aspect, a method for fabricating an orifice for a hydrostatic device is provided. The method includes providing a body, disposing at least one outlet opening on the body, and disposing a plurality of inlet surface openings on the body in flow communication with the outlet. Each inlet surface opening is smaller than the outlet opening.

In a further aspect, an orifice for a hydrostatic system includes a body, at least one outlet opening disposed on the body, and a plurality of inlet surface openings disposed on the body in flow communication with the outlet. Each inlet surface opening is smaller than the outlet opening.

### BRIEF DESCRIPTION OF DRAWINGS

FIG. 1 is a side view of a multi-inlet orifice.

FIG. 2 is a plan view of a lubrication system including the multi-inlet orifice shown in FIG. 1.

FIG. 3 is side view of a precision multi-inlet orifice.

FIG. 4 is a side view of a central thread multi-inlet orifice.

### DETAILED DESCRIPTION

FIG. 1 is a side view of a multi-inlet orifice 10 including a first end 12, a second end 14, and an outer surface 16 extending from first end 12 to second end 14. Multi-inlet orifice 10 also includes a plurality of inlet surface openings 18, at least one inlet end opening 20, an outlet opening 22, and an axis 24. In an alternative embodiment, multi-inlet orifice does not include any inlet end openings 20. In one embodiment, outer surface 16 includes a threaded portion 26 proximate second end 14. An outlet channel 28 extends from an interior end 30 to outlet opening 22. A plurality of inlet channels 32 extend from outlet channel 28 to inlet surface openings 18 such that inlet surface openings 18 are in flow communication with outlet opening 22. In one embodiment, inlet channels 32 extend linearly and substantially radially to inlet surface openings 18. In an alternative embodiment, inlet channels 32 extend obliquely to surface openings 18. In another embodiment, inlet channels 32 include one or more curved portions (not shown). In an exemplary embodiment, multi-inlet orifice 10 includes eight or more inlet surface openings 18.

At least one axial inlet channel 34 extends from interior end 30 to inlet end opening(s) 20 such that inlet end opening(s) 20 are in flow communication with outlet opening 22. In one embodiment, axial inlet channel 34 extends linearly and substantially axially from interior end 30 to inlet end opening(s) 20. In an alternative embodiment, axial channel 34 extends obliquely from interior end 30 to inlet opening(s) 20. In another embodiment, axial channel 34 includes one or more curved portions (not shown). Inlet surface openings 18 and inlet end opening(s) 20 are substantially circular and include a radius (not shown) less than a radius (not shown) of outlet opening 22, which is also substantially circular. In an exemplary embodiment, inlet surface openings 18 and inlet end opening(s) 20 have substantially similar diameters. In an alternative embodiment, inlet surface openings 18 and inlet end opening(s) 20 and outlet opening 22 are square and inlet surface openings 18 and inlet end opening(s) 20 are smaller than outlet opening 22. In an exemplary embodiment, multi-inlet orifice 10 is fabricated from a metal, including, but not limited to, aluminum, brass, copper, and steel. In an alternative exemplary embodiment, multi-inlet orifice 10 is fabricated from a non-metal, including, but not limited to, plastics, ceramics, crystals, and composites.

During operation, a lubricating fluid (not shown) flows in inlet surface openings 18 and inlet end opening(s) 20, and flows out outlet opening 22. Since inlet surface openings 18 and inlet end opening(s) 20 are smaller than outlet opening 22, debris that enters any particular inlet surface opening 18 and/or inlet end opening(s) 20 is sufficiently small to pass through outlet opening 22. Accordingly, the debris does not block outlet opening 22. It is contemplated that the benefits of a multi-inlet orifice 10 accrue to orifices with inlet openings (surface and/or end) and outlet openings of varying shape, including, but not limited to, shapes with at least one line of symmetry and shapes with no line of symmetry. Furthermore, because there are a plurality of inlet surface openings 18 in combination with inlet end opening(s) 20, a blockage of less than all of inlet surface opening 18 and inlet end opening(s) 20 does not prevent lubrication fluid from entering a different inlet surface opening 18 and/or inlet end opening(s) 20, and exiting through outlet opening 22. In other words, a blockage of less than all of openings 18 and 20 does not cause a blockage of outlet opening 22.

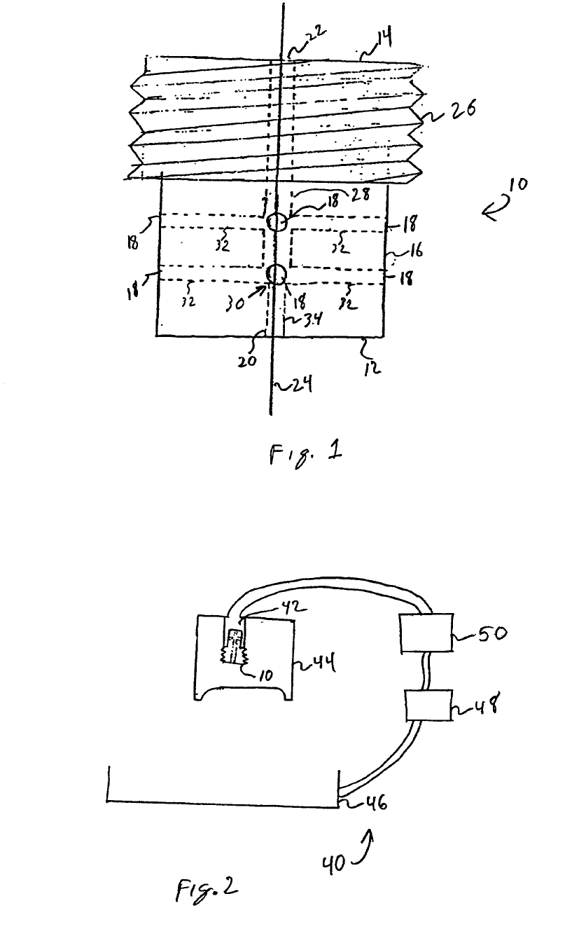

FIG. 2 is a plan view of a lubrication system 40 including multi-inlet orifice 10 shown in FIG. 1. Lubrication system 40 includes multi-inlet orifice 10, a lubrication channel 42, a hydrostatic system 44, a sump 46, a filter 48, and a pump 50. Multi-inlet orifice 10 is positioned within lubrication channel 42 such that inlet surface openings 18 and inlet end opening(s) 20 receive a lubrication fluid (not shown) from pump 50. Outlet opening 22 is in flow communication with hydrostatic system 44. Filter 48 is positioned between sump 46 and pump 50.

During operation of lubrication system 40, lubrication fluid is in sump 46. Pump 50 draws the fluid from sump 46 through filter 48 and delivers the fluid to lubrication channel 42 thereby pressurizing lubrication channel 42. Since the lubrication fluid in channel 42 is pressurized, the fluid flows in inlet surface openings 18 and inlet end opening(s) 20, and the fluid flows out outlet opening 22 to hydrostatic system 44 where the fluid lubricates at least one moving part (not shown). The fluid then returns to sump 46 to be re-circulated. Although filter 48 removes debris from the fluid, the fluid can pick up debris originating between filter 48 and multi-inlet orifice 10. Since multi-inlet orifice 10 includes a plurality of inlet surface openings 18 in combination with inlet end opening(s) 20, a blockage of less than all of inlet surface opening 18 and inlet end opening(s) 20 does not cause a blockage of outlet opening 22. Accordingly, hydrostatic system 44 receives fluid not withstanding a blockage of less than all of inlet surface openings 18 and inlet end opening(s) 20. It is contemplated that the benefits of a multi-inlet orifice accrue to hydraulic systems and, therefore, as used herein the term “hydrostatic” includes “hydraulic”.

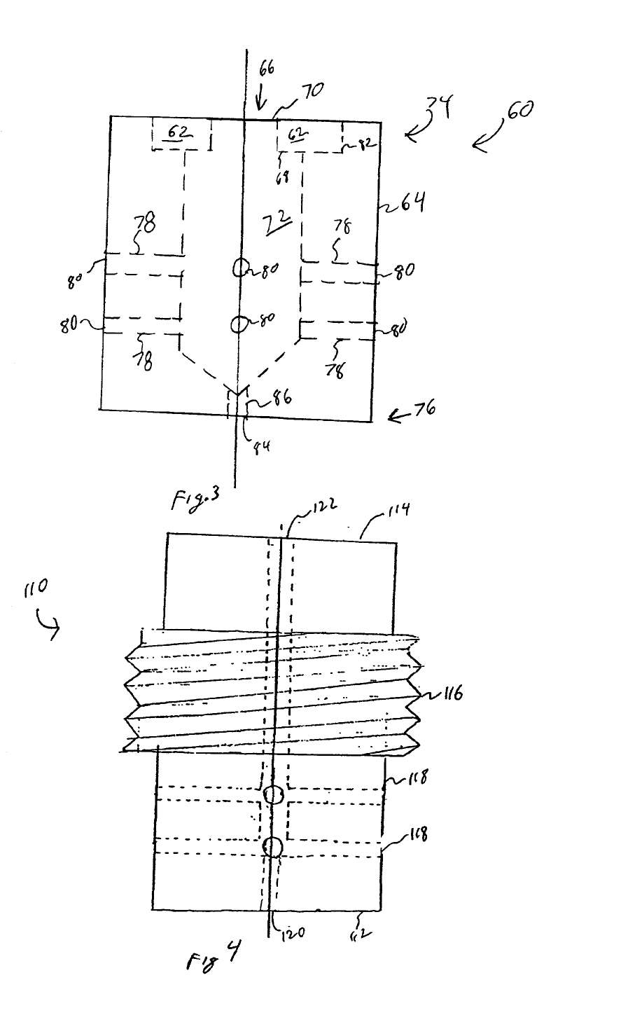

FIG. 3 is a side view of a precision multi-inlet orifice 60 including a precision control unit 62 and a body 64. Precision control unit 62 includes an axial bore 66 that extends from an interior end 68 to an outlet opening 70. In one embodiment, precision control unit 62 is fabricated from a crystal. In another embodiment, precision control unit 62 is fabricated from a material other than crystal. Body 64 includes a first axial bore 72 extending from a first end 74 of body 64 toward a second end 76 of body 64. Body 64 also includes a plurality of inlet channels 78 that extend from first axial bore 72 to a plurality of inlet surface openings 80. Bore 72 includes a diameter (not shown) at least as large as a diameter (not shown) as bore 66. Inlet channels 78 are have cross-sections sized smaller than a cross-section (not shown) of bore 66 such that any particle sufficiently small enough to pass through inlet channels 78 can pass through bore 66. In an exemplary embodiment, inlet channels 78 extend radially to inlet surface openings 80. In an alternative embodiment, inlet channels 78 extend obliquely from first axial bore 72 to inlet surface openings 80. In one embodiment, inlet channels 78 include one or more arcuate sections (not shown). In an exemplary embodiment, there are eight inlet channels 78 positioned in two rows of four and, within each row, inlet channels 78 are spaced 90 apart circumferentially.

Body 64 also includes a shoulder 82 selectively sized to receive precision control unit 62. In one embodiment, precision multi-inlet orifice 60 is attached to a hydrostatic system such as system 44 (shown in FIG. 2) in conventional manner such as keying, press fitted (friction fitted), peening, doweling and/or adhesively attached. In another embodiment, body 64 includes a threaded portion (not shown) substantially identical to threaded portion 26 of multi-inlet orifice 10 (shown in FIG. 1) and precision multi-inlet orifice is threadibly attached to the hydrostatic system. Body 64 also includes at least one inlet end opening 84 in flow communication with first axial bore 72 via at least one axial channel 86. In an alternative embodiment, body 64 does not include any inlet end openings 84 During operation, fluid flows in inlet surface openings 80 and inlet end opening (s) 84, through inlet channels 78 and axial channel 86, and then through bore 72 to bore 66. The fluid flows through bore 66 out outlet opening 70. Since inlet surface openings 80 and inlet end opening(s) 90 are smaller than outlet opening 70, debris that enters any particular inlet surface opening 80 and/or inlet end opening(s) 90 is sufficiently small to pass through outlet opening 70. Additionally, since precision multi-inlet orifice 60 includes a plurality of inlet surface openings 84 and inlet end opening(s) 90, a blockage of less than all particular inlet surface opening 80 and/or inlet end opening(s) 90 does not cause a blockage of outlet opening 70.

FIG. 4 is a side view of a central thread multi-inlet orifice 110 including a first end 112 and a second end 114. Central thread multi-inlet orifice 110 also includes a central thread portion 116 disposed between first end 112 and second end 114. Central thread multi-inlet orifice 110 also includes a plurality of inlet surface openings 118 extending outward and at least one end outlet 120 extending substantially axially. Central thread multi-inlet 110 also includes an outlet opening 122 extending substantially axially.

During operation of central thread multi-inlet orifice 46 in a lubrication system 40 as shown in FIG. 2, central thread multi-inlet orifice operates 46 as described above with reference to multi-inlet orifice 10.

While the invention has been described in terms of various specific embodiments, those skilled in the art will recognize that the invention can be practiced with modification within the spirit and scope of the claims.

1. An orifice for a hydrostatic system said orifice comprising:
a plurality of means for providing flow communication from a first side of said orifice to a second side of said orifice such that the flow communication is maintained when less than all of said means are blocked.

2. A method for fabricating an orifice for a hydrostatic device, said method comprising:
providing a body;
disposing at least one outlet opening on the body;
disposing a plurality of inlet surface openings on the body in flow communication with the outlet, each inlet surface opening smaller than the outlet opening.

3. A method according to claim 2 wherein said disposing a plurality of inlet surface openings comprises disposing a plurality of inlet surface openings on the body in flow communication with the outlet via a plurality of inlet channels.

4. A method according to claim 2 wherein said disposing a plurality of inlet surface openings comprises disposing a plurality of inlet surface openings on the body in flow communication with the outlet via a plurality of inlet channels and an outlet channel, each inlet channel having a smaller cross-section than a cross-section of the outlet channel.

5. A method according to claim 2 further comprising disposing at least one inlet end opening on the body in flow communication with the outlet channel, each inlet end opening smaller than the outlet opening.

6. A method according to claim 4 further comprising disposing at least one inlet end opening on the body in flow communication with the outlet channel via an axial inlet channel, each inlet end opening smaller than the outlet opening, each axial inlet channel having a smaller cross-section than the cross-section of the outlet channel.

7. A method according to claim 2 wherein said disposing a plurality of inlet surface openings comprises disposing a plurality of inlet surface openings having a substantially circular shape on the body in flow communication with the outlet, each inlet surface opening having a radius less than a radius of the outlet opening.

8. A method according to claim 2 wherein said providing a body comprises providing a body including a precision control unit, said disposing at least one outlet opening comprises disposing at least one outlet opening on the precision control unit.

9. A method according to claim 8 further comprising disposing a plurality of unit openings on the precision control unit such that the unit openings are in flow communication with the outlet opening and the inlet surface openings.

10. A method according to claim 8 further comprising disposing a plurality of unit openings on the precision control unit such that each unit opening is in flow communication with the outlet opening via a non-axial bore, and each unit opening is in flow communication with a particular inlet surface opening via a body channel.

11. A method according to claim 10 further comprising disposing at least one inlet end opening on the body in flow communication with the outlet opening via an axial opening on the precision control unit.

12. An orifice for a hydrostatic system, said orifice comprising:
a body;
at least one outlet opening disposed on said body;
a plurality of inlet surface openings disposed on said body in flow communication with said outlet, each inlet surface opening smaller than said outlet opening.

13. An orifice according to claim 12 wherein each said inlet surface opening is in flow communication with said outlet via an inlet channel and an outlet channel.

14. An orifice according to claim 12 wherein each said inlet surface opening is in flow communication with said outlet via an inlet channel and an outlet channel, each inlet channel having a smaller cross-section than a cross-section of said outlet channel.

15. An orifice according to claim 12 further comprising at least one inlet end opening disposed on said body in flow communication with said outlet channel, each inlet end opening smaller than said outlet opening.

16. An orifice according to claim 12 further comprising at least one inlet end opening disposed on said body in flow communication with said outlet channel via an axial inlet channel, each inlet end opening smaller than said outlet opening, each axial inlet channel having a smaller cross-section than said cross-section of said outlet channel.

17. An orifice according to claim 12 wherein each said inlet surface openings have a substantially circular shape including a radius, said outlet has a substantially circular shape including a radius greater than each said radius of said inlet surface openings.

18. An orifice according to claim 12 further comprises a precision control unit mounted in a shoulder of said body.
